(19) United States
(12) Patent Application Publication
(10) Pub. No.: US 2018/0336262 A1
(43) Pub. Date: Nov. 22, 2018

(54) GEOMETRIC APPROACH TO PREDICATE SELECTIVITY

(71) Applicant: Futurewei Technologies, Inc., Plano, TX (US)

(72) Inventor: Ahmad Ghazal, Redondo Beach, CA (US)

(73) Assignee: Futurewei Technologies, Inc., Plano, TX (US)

(21) Appl. No.: 15/600,639

(22) Filed: May 19, 2017

(51) Int. Cl. G06F 17/30

(52) U.S. Cl. CPC G06F 17/30592

(57) ABSTRACT

The disclosure relates to technology for estimating selectivity of non-join multi-column (NJMC) predicates of multi-column table (MCT) database queries is disclosed. The selectivity may be geometrically estimated by representing the full space of the MCT as one polyhedron having at least one dimension for each column of the MCT, and representing the NJMC predicate space as another polyhedron having at least one dimension for each column of a predicate space determined by applying the NJMC predicate to the MCT. Then the selectivity of the NJMC predicate may be estimated by computing a percentage of the size of the NJMC predicate space polyhedron to the size of the full space polyhedron. This more accurate estimate helps database query optimizers produce better query execution plans that utilize system resources more efficiently.

### FIELD

Embodiments described herein are related in general, to a database management system (DBMS) query optimizers and, more particularly, to estimating selectivity for a non-join multi-column (NJMC) predicate of a database query.

### BACKGROUND

Database management systems (DBMS) typically store, maintain and return data through user applications and other systems. Usually, DBMS return data to answer and process user queries. Such user queries are typically sent in the form of the standard query language (SQL) which is adapted by the vast majority of DBMS and recently Hadoop based systems. SQL queries may involve joining and aggregating data from user tables and could be quite complex and require a lot of systems resources such as computer processors (e.g., central processing units—CPUs), computer memory and computer networks.

In general, a DBMS may consider many different ways (execution plans) to execute a SQL query. The variety of the SQL execution plans may be a result of the existence of different ways or possibilities for the data to be accessed or processed. Some options include, but are not limited to, different join orders (e.g., there may be n! ways of ordering n joins), different join methods (e.g., hash, merge, nested loop joins) and different ways a table can be accessed (e.g., index or non-index access). One of the challenges DBMS face is choosing the best (or a reasonable) query execution plan from all of the possible different execution plans. Choosing an execution plan is generally accomplished by one of the components of a DBMS called a query optimizer or simply an optimizer. Choosing a “bad” plan by the optimizer could lead to poor system performance or, in the worst case, the system could be un-available to other users' queries. Therefore, building an intelligent optimizer may be an important part of a successful DBMS. A difficult and important goal in query optimization may be to figure out the percentage of database table rows that satisfies a given predicate. This percentage is commonly referred to as the selectivity—the percentage of database table rows that satisfies a given predicate.

### BRIEF SUMMARY

According to one aspect of the present disclosure, there is provided a method that includes: representing a full space of a multi-column table (MCT) as a first polyhedron having at least one dimension for each column of the multi-column table, representing a non-join multi-column (NJMC) predicate space as a second polyhedron having at least one dimension for each column of a predicate space determined by applying an NJMC predicate to the multi-column table, and estimating a selectivity of the NJMC predicate by computing a percentage of a second size of the second polyhedron to a first size of the first polyhedron.

According to one aspect of the present disclosure, there is provided an apparatus that includes a memory storage comprising instructions, and one or more processors in communication with the memory, wherein the one or more processors execute the instructions to represent a full space of a multi-column table (MCT) as a first polyhedron having at least one dimension for each column of the multi-column table, represent a non-join multi-column (NJMC) predicate space as a second polyhedron having at least one dimension for each column of a predicate space determined by applying an NJMC predicate to the multi-column table, and estimate a selectivity of the NJMC predicate by computing a percentage of a second size of the second polyhedron to a first size of the first polyhedron.

According to one aspect of the present disclosure, there is provided a non-transitory computer-readable medium storing computer instructions for computing a selectivity estimation of a database query, that when executed by one or more processors, cause the one or more processors to perform the steps of represent a full space of a multi-column table (MCT) as a first polyhedron having at least one dimension for each column of the multi-column table, represent a non-join multi-column (NJMC) predicate space as a second polyhedron having at least one dimension for each column of a predicate space determined by applying an NJMC predicate to the multi-column table, and estimate a selectivity of the NJMC predicate by computing a percentage of a second size of the second polyhedron to a first size of the first polyhedron.

Optionally, in any of the preceding aspects, another implementation of the aspect provides that the estimating further includes calculating the first size as one of a hyper volume in n-dimensions, or a number of integer points of the first polyhedron, calculating the second size as one of a hyper volume in n-dimensions, or a number of integer points of the second polyhedron, and the computing the percentage includes dividing the second size by the first size.

Optionally, in any of the preceding aspects, another implementation of the aspect provides that the representing the full space includes identifying a plurality of variables for columns of the multi-column table, and the estimating includes applying a range of values to each of the plurality of variables to determine the first size, restricting the first size using the NJMC predicate to determine the second size, and estimating the selectivity as a percentage of the second size divided by the first size.

Optionally, in any of the preceding aspects, another implementation of the aspect provides that the representing the full space includes defining the first polyhedron as a first n-dimensional, bounded polyhedron based on statistical calculations or estimations used on a plurality of columns of the multi-column table, and the representing the NJMC predicate space includes defining the second polyhedron as a second n-dimensional, bounded polyhedron based on statistical calculations or estimations used on a plurality of columns of the NJMC predicate space that are a subset of the plurality of columns of the multi-column table.

Optionally, in any of the preceding aspects, another implementation of the aspect provides that prior to representing a full space, the method further includes identifying a skew of data in the multi-column table, and compensating for the skew by one of a) applying a correlation constraint to the multi-column table that reduces the first polyhedron to a smaller sized third polyhedron and reduces the second polyhedron to a smaller sized fourth polyhedron, or b) applying a geometric solution to equal-depth multi-dimensional histograms of the multi-column table.

Optionally, in any of the preceding aspects, another implementation of the aspect provides that applying a geometric solution includes selecting a plurality of equal-depth multi-dimensional histograms, separately applying a geometric solution to each of the selected equal-depth multi-dimensional histograms, and compensating for the skew based on adding the results from the separately applying.

Optionally, in any of the preceding aspects, another implementation of the aspect provides that the method further includes calculating a cardinality of the NJMC predicate using the estimated selectivity.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

Aspects of the present disclosure are illustrated by way of example and are not limited by the accompanying figures for which like references indicate like elements.

FIG. 1 illustrates an example diagram of a database management system (DBMS) in which query processing may be implemented according to an embodiment.

FIG. 2 shows an example of a framework of query processing in a database management system (DBMS) of FIG. 1 according to an embodiment.

FIG. 3 is a table illustrating actual and estimated selectivity for some example NJMC queries according to an embodiment.

FIGS. 4A-4B show two alternative hash join plans for a query having an NJMC predicate according to an embodiment.

FIG. 5 is an example of the geometric representation showing an NJMC predicate.

FIG. 6 is an example of the geometric representation showing an NJMC predicate.

FIG. 7 is a table illustrating actual selectivity, geometric estimated selectivity, and geometric estimated selectivity with correlation constraint to compensate for skew for some example queries having NJMC predicates.

FIG. 8 is an example of the geometric representation showing an NJMC predicate having equi-depth histograms with two buckets according to an embodiment.

FIG. 9A is a flow diagram of a process for performing a portion of query optimization according to example embodiments.

FIG. 9B is a flow diagram of a process for performing geometric selectivity estimation according to example embodiments.

FIG. 9C is a flow diagram of a process for performing geometric selectivity estimation according to example embodiments.

FIG. 10 is a flow diagram of a process for performing skew compensation as part of geometric selectivity estimation according to example embodiments.

FIG. 11 illustrates a block diagram of a system that can be used to implement various embodiments

### DETAILED DESCRIPTION

The technology disclosed herein relates to database query performance through selectivity estimation.

Some embodiments herein include approaches for computing (e.g., estimating) non-join multi-column (NJMC) predicate selectivity estimation of a database query (e.g., to be performed, such as by a DBMS of a relational database) which helps database query optimizers produce better query execution plans that utilize system resources more efficiently.

In more detail, embodiments described herein improve results of queries (e.g., searches to select information) to multi-column tables (MCT) of relational databases that include NJMC predicates (e.g., search terms). In some instances, a query optimizer of a DBMS selects a better plan (e.g., more efficient or that will use less system resources) for the query from different possible plans by more accurately estimating the percentage of database table rows that will satisfy an NJMC predicate (selectivity). The more accurate estimate of selectivity helps the query optimizer pick the best execution plan for that query from the different possible plans.

In some embodiments, the query optimizers may more accurately estimate selectivity of the NJMC predicates by representing the full space of all the rows of the columns of the MCT related to (e.g., involved in) the query (e.g., “full space of the MCT” for the query) as one polyhedron and NJMC predicate space the rows of the columns of the MCT that satisfy the NJMC predicate of the query (e.g., “NJMC predicate space” for the query) as another polyhedron that is a subset of the first polyhedron as constricted by the NJMC predicate (e.g., using a “geometric approach”).

In one example, the full space of the MCT may be represented as one polyhedron having at least one dimension for each column of the multi-column table, each dimension with a length based on or equal to the rows of that column. The NJMC predicate space may be represented as another polyhedron having at least one dimension for each column of a predicate space determined by applying an NJMC predicate to the multi-column table, each of these dimensions with a length based on or equal to the rows of that column that satisfy the NJMC predicate. The query optimizer may estimate selectivity of the NJMC predicate by computing a percentage of the size of the NJMC predicate space polyhedron to the size of the full space polyhedron.

Some embodiments herein provide methods and devices for more accurately computing (e.g., estimating) selectivity of NJMC predicates of a database query, which helps database query optimizers produce better query execution plans, avoid producing poorly performing plans (e.g., “bad” plans) for queries, and utilize system resources more efficiently. One example embodiment estimates selectivity of an NJMC predicate which is neither a join predicate nor a single column predicate, but is an NJMC predicate based on representing the full space of the table and the NJMC predicate space as a polyhedrons, and then using the size (volume or number of integer points) proportion of those polyhedrons to estimate selectivity. In some instances, such an approach may be described as “a geometric approach to predicate selectivity”. In some instances, such an approach may be described as providing “geometric estimated selectivity” or as a “geometric estimated selectivity solution.”

It is understood that the present subject matter may be embodied in many different forms and should not be construed as being limited to the embodiments set forth herein. Rather, these embodiments are provided so that this subject matter will be thorough and complete and will fully convey the disclosure to those skilled in the art. Indeed, the subject matter is intended to cover alternatives, modifications and equivalents of these embodiments, which are included within the scope and spirit of the subject matter as defined by the appended claims. Furthermore, in the following detailed description of the present subject matter, numerous specific details are set forth in order to provide a thorough understanding of the present subject matter. However, it will be clear to those of ordinary skill in the art that the present subject matter may be practiced without such specific details.

The relational model (RM) for database management is an approach to managing data using a structure and language consistent with first-order predicate logic, where all data is represented in terms of tuples, grouped into relations. A database organized in terms of the relational model is a relational database.

One purpose of the relational model is to provide a declarative method for specifying data and queries: users directly state what information the database contains and what information they want from it, and let the database management system (DBMS) software take care of describing data structures for storing the data and retrieval procedures for answering queries.

Most relational databases use the (standard query language) SQL data definition and query language; these systems implement what can be regarded as an engineering approximation to the relational model. A table in an SQL database schema corresponds to a predicate variable; the contents of a table to a relation; key constraints, other constraints, and SQL queries correspond to predicates. However, SQL databases deviate from the relational model in many details, and some fiercely argue against deviations that compromise the original principles.

The relational model's central idea is to describe a database as a collection of predicates over a finite set of predicate variables, describing constraints on the possible values and combinations of values. The content of the database at any given time is a finite (logical) model of the database, i.e. a set of relations, one per predicate variable, such that all predicates are satisfied. A request for information from the database (a database query) is also a predicate.

Users (or programs) request data from a relational database by sending it a query that may be written in a special language, usually a dialect of SQL. Although SQL was originally intended for end-users, it is much more common for SQL queries to be embedded into software that provides an easier user interface. In response to a query, the database returns a result set, which may be just a list of rows containing the answers. The simplest query may be just to return all the rows from a table, but more often, the rows are filtered in some way to return just the answer wanted. Often times, data from multiple tables are combined into one single table, by performing a join. Conceptually, this can done by taking all possible combinations of rows (the Cartesian product), and then filtering out everything except the answer. In practice, relational database management systems may rewrite (“optimize”) queries to perform faster, using a variety of techniques.

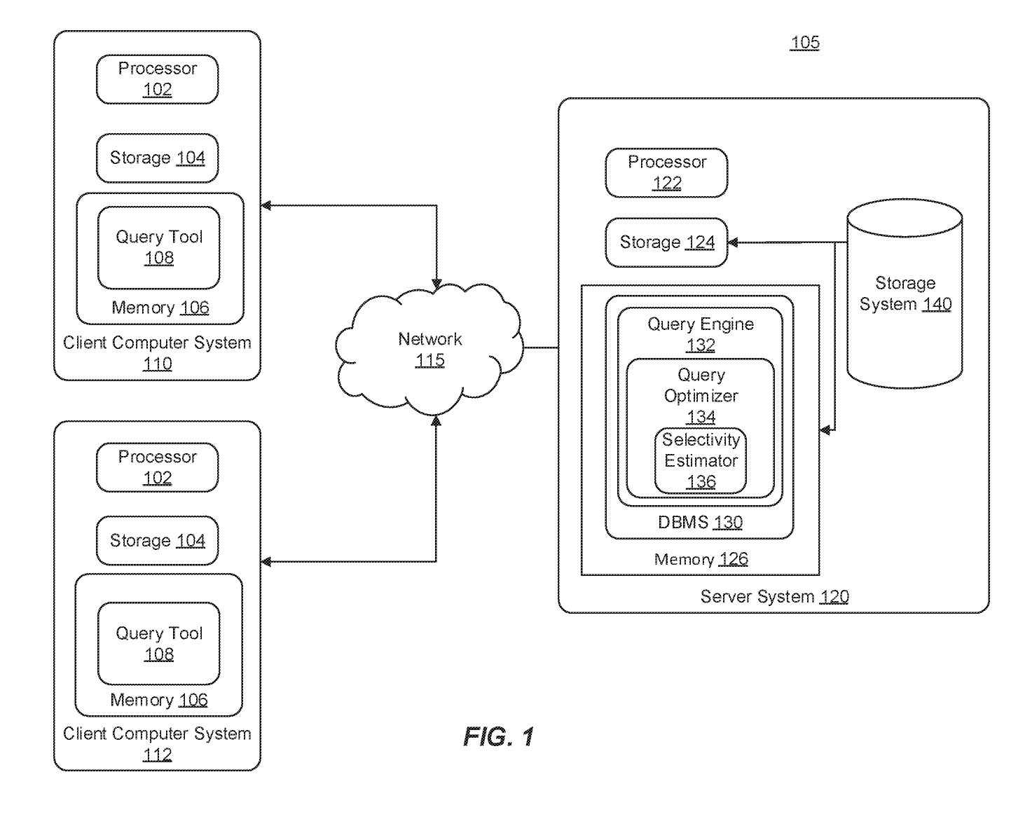

FIG. 1 illustrates an example diagram of a database management system (DBMS) in which query processing may be implemented. As shown, computing environment 105 includes two client computer systems 110 and 112, a network 115 and a distributed server system 120. The computer systems illustrated in environment 105 are included to be representative of existing computer systems, e.g., desktop computers, server computers, laptop computers, tablet computers and the like. However, embodiments of the present disclosure are not limited to any particular computing system, application or network architecture and may be adapted to take advantage of new computing systems as they become available. Additionally, those skilled in the art will recognize that the computer systems illustrated in FIG. 1 are simplified to highlight aspects of the present embodiments and that computing systems and networks typically include a variety of additional elements not shown. For example, the system is not limited to two client computing systems or a single server, but may include any number of systems and servers. Environment 105 may be used to or part of an environment that provides geometric estimated selectivity for NJMC predicates.

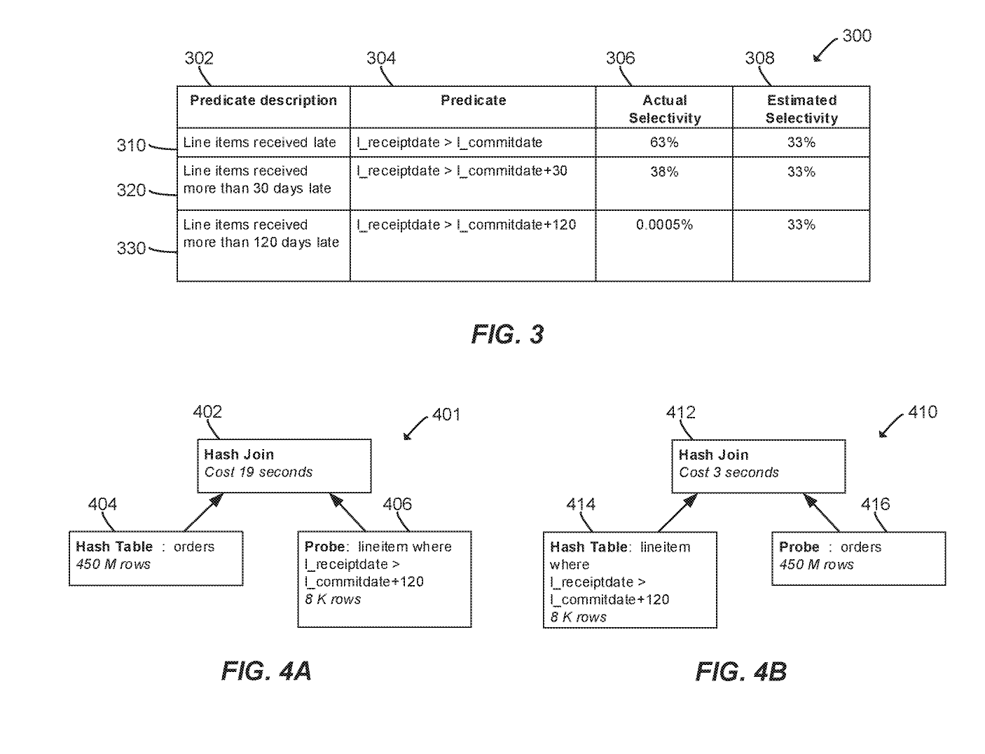

Client computer systems 110 and 112 each include, for example, a processor 102, storage 104 and memory 106, typically connected by a bus (not shown). Processor 102 is, for example, a programmable logic device that performs the instructions and logic processing performed in executing user applications. Although illustrated as a single processor, the processor 102 is not so limited and may comprise multiple processors. The processor 102 may be implemented as one or more central processing unit (CPU) chips, cores (e.g., a multi-core processor), field-programmable gate arrays (FPGAs), application specific integrated circuits (ASICs), and/or digital signal processors (DSPs), and/or may be part of one or more ASICs. The processor 102 may be configured to implement any of the schemes described herein, such as the processes illustrated in FIGS. 3-11, using any one or combination of steps described in the embodiments. Moreover, the processor 102 may be implemented using hardware, software, or a combination of hardware and software.

Storage 104 may store application programs and data for use by client computer systems 110 and 112. Storage 104 includes hard-disk drives, flash memory devices, optical media and the like.

Client computer systems 110 and 112 may also run a query tool 108, which is stored in memory 106. The memory 106 is illustrated as a single memory, although memory 106 may be implemented as a combination of read only memory (ROM), random access memory (RAM), or storage 104 (e.g., one or more disk drives or tape drives used for non-volatile storage of data). In one embodiment, query tool 108 may allow a user to compose a query, where query tool 108 is configured to automatically determine Boolean logic and generate a predicate, for example, as a Boolean expression. Additionally, query tool 108 may be configured to transmit a query over network 115 to server system 120 for execution by a database management system (DBMS) 130. In embodiments, the network 215 may comprise the Internet, though other networks including, but not limited to, a LAN or WAN are contemplated. Computer systems 110/112 and server system 120 may be connected to each other by direct wireless personal area networks (WPANs) and/or peer-to-peer connections in addition to, or instead of, their connection to network 115.

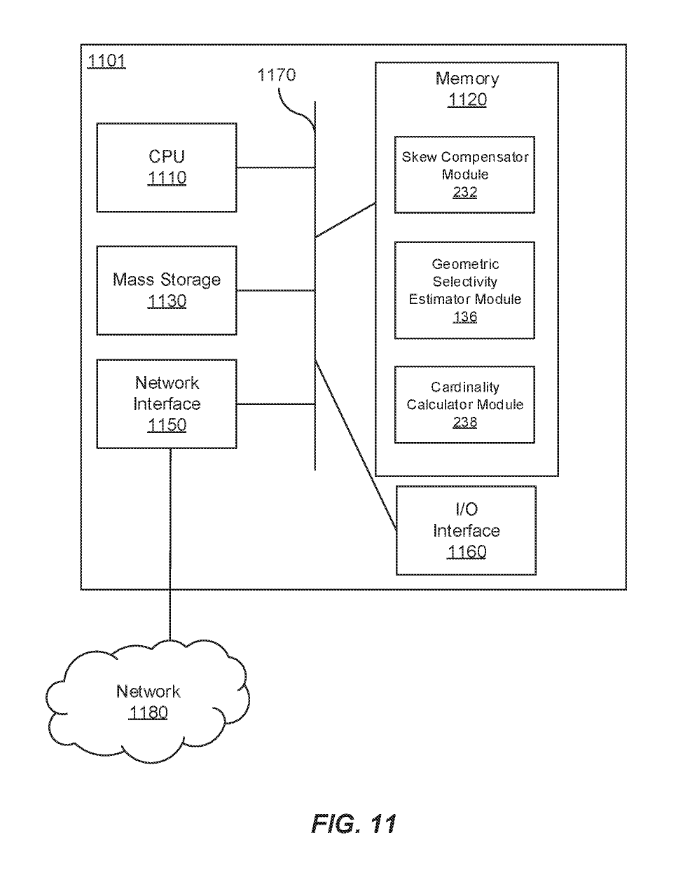

Server system 120 includes, for example, a processor 122, storage 124 and memory 126. Storage 124 also includes a storage system 140 (or database). Storage system 140, although depicted as part of the server system 120, may also be located outside of the server system 120 and communicatively coupled to the network 115. Moreover, it is appreciated that there may be more than one storage system (or database), and that the storage system may be any type of known database, database system, data stores, and the like. In some instances, server system 120 includes components (e.g., modules) shown in processing unit 1101 of FIG. 11.

In one embodiment, the DBMS 130 is a software application configured to manipulate the information in storage system 140. For example, DBMS 130 may be configured to add, delete, modify, sort, display and search for specific information stored in storage system 140. In the depicted embodiment, DBMS 130 includes a query engine 132 which represents the instructions or routines included in DBMS 130 that evaluate logical operators and query conditions, according to a set of rules as described herein.

The query engine 132 includes query optimizer 134 which includes selectivity estimator 136. According to embodiments, query optimizer 134 may consider many different ways (plans) to execute a SQL query. Considering the variety of the SQL execution plans may be a result of the query optimizer 134 knowing of the existence of different ways or possibilities for the data to be accessed or processed. Some of these options may be: different join orders (e.g., there may be n! ways of ordering n joins), different join methods (e.g., hash, merge, nested loop joins) and different ways a table can be accessed (e.g., index or non-index access). One of the challenges the query optimizer 134 may face is choosing the best (or a reasonable) query execution plan from all these possible different execution plans. Choosing a “bad” plan by the optimizer could lead to poor system performance or in the worst case the system could be un-available to other users' queries. Therefore, building an intelligent optimizer may be an important part of a successful query optimizer 134. One of the goals of query optimization may be for the query optimizer 134 to figure out the percentage of database table rows that satisfies a given predicate. This percentage may be called “selectivity.” Query optimizer 134 may include selectivity estimator 136 to estimate or calculate the percentage of database table rows that satisfies a given predicate. In some cases, selectivity estimator 136 to estimate or calculate the percentage of database table rows that satisfies a given NJMC predicate. That is, estimator 136 may estimate selectivity of a specific NJMC predicate of a database query that is or includes the NJMC predicate. This query may be one already requested by a user and to occur in the near future, such as a query that the estimation is part of performing the query optimization for.

For example, if we assume a 1,000 row table called t1 with two columns c1 and c2 and the query “select * from t1 where c1>50”. If there are 100 rows in t1 that satisfies the predicate “c1>50” then the selectivity of this predicate is 10%.

In various embodiments, the query engine 132 can utilize selectivity estimator module 134 to generate selectivity estimates for NJMC predicates, for each specific NJMC query that is submitted, rather than using less accurate NJMC predicate estimate processes or using default NJMC predicate selectivity estimates (e.g., for any or all possible NJMC predicate queries). The NJMC predicate queries can be submitted, for example, by a user operating a client computer system 112 to interact with an interface. By generating more accurate NJMC predicate selectivity estimates, the query execution engine 132 can help database query optimizers produce better query execution plans that utilize system resources more efficiently. More accurate selectivity estimates can also allow for specific optimizations to be performed that are tailored with respect to the NJMC predicates of a query, thereby helping achieve optimal query execution performance. For instance, more accurate cardinalities may be calculated using the more accurate selectivity estimates.

In some instances, an NJMC predicates and its corresponding selectivity estimate may be for an NJMC predicate that is part of a larger query. For example, an NJMC predicates and it's corresponding selectivity estimate may be for a larger predicate that includes at least one NJMC predicate as well as that includes other non-NJMC predicates.

In one embodiment, the query tool 108 generates a query from user specified query conditions. The queries generated by query tool 108 may be used to retrieve data from storage system 140.

In some instances, each of query engine 132, query optimizer 134 and selectivity estimator 136 may be referred to as processors, modules or components, and may each be executed on a single processor or separate processors. In some embodiments, they may further include one or more elements for performing any one or combination of steps described in the embodiments. In some instances, the functional components (e.g., query engine 132, query optimizer 134 and selectivity estimator 136) can each be described as a “module” such as a component which is or includes software, hardware, computer logic, another known computer component, a processors, or a combination thereof. In accordance with various embodiments of the present disclosure, the methods described herein (e.g., performed by query engine 132, query optimizer 134 and selectivity estimator 136) may be implemented using a hardware computer system that executes software programs.

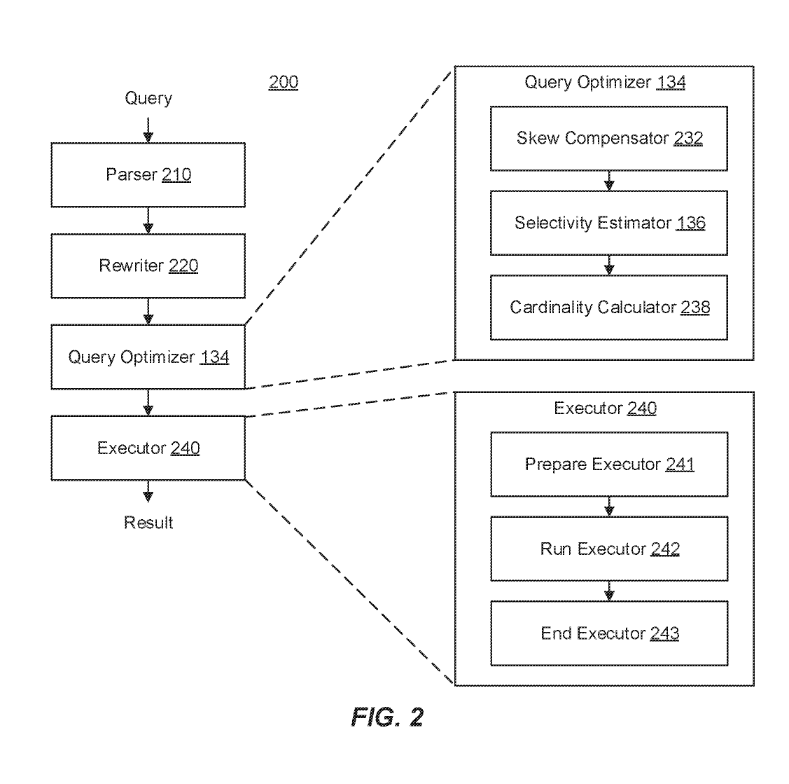

FIG. 2 shows an example of a framework 200 of query processing in a database management system (DBMS) of FIG. 1. An incoming query (e.g., shown as “Query”) is first parsed by a parser 210 by performing semantic checks on the query to ensure that it is well formed. Upon completion of parsing, a parse tree or query tree is output that represents the logical steps necessary to execute the requested query. Framework 200 may be used to or part of a process to provide geometric estimated selectivity for NJMC predicates.

The rewriter (or transformer) 220 takes the parsed query, typically in the form of query blocks nested or interrelated to each other, output from parser 210 The rewriter 220 primary objective is to determine whether it is advantageous to change the form of the query so that it enables generation of a better query plan. Several different query transformation techniques may be employed by the rewriter 220, such as view merging, predicate pushing, query rewrite with materialized views, subquery unnesting, etc.

Query optimizer (or planner) 134 may determine an efficient execution mechanism in which to execute a given query by considering possible query plans (or execution plans). This may be accomplished, for example, using the parse tree previously created along with statistical information about the data, to generate one or more query plans for each query, each of which may be a mechanism used to run a query. Various decisions made by the optimizer 134 may be based on calculated costs of an execution plan, in terms of CPU processing and input/output (I/O), along with how fast the query may be executed (i.e., a cost-based plan). In some instances, the execution plans are then evaluated and the lowest-cost plan (i.e., execute fasters and use least amount of resources, CPU and I/O) is often, but not always, selected.

In some instances, part of the query optimizer 134 determining an efficient execution mechanism (e.g., a “good plan”) in which to execute a given query by considering possible query plans (or execution plans) includes optimizer 134 estimating the selectivity of the query. This may include estimating the selectivity of an NJMC predicate that is all or is part of that query. Optimizer 134 may use selectivity estimator 136 as a process and/or module to estimate the selectivity of a query that includes an NJMC predicate, such as described herein. In some cases, optimizer 134 may optionally use skew compensator 232 as a process and/or module to compensate for skew (e.g., frequency of values and/or data spread), such as described herein, as part of or before estimating the selectivity of a query that includes an NJMC predicate by estimator 136. In some cases, optimizer 134 may optionally use cardinality calculator 238 as a process and/or module to calculate cardinality (e.g., based on or using the selectivity estimated by estimator 136), such as described herein, as part of or after estimating the selectivity of a query that includes an NJMC predicate by estimator 136.

Data skew, (e.g., “skew”) in a database may describe that the data in the database is not evenly distributed across partitions or columns. In some instances, the number of data points will be unevenly spread amongst the columns of a table, such as by having more points to the left (e.g., negative skew) or right (e.g., negative skew) of center of the columns considered. An uneven distribution (e.g., skew) can degrade required increased system resources (e.g., degrade the performance of the overall execution) such as by causing CPUs to sit idle and wait (instead of searching the columns those CPUs are assigned to search in a query plan) while the query to plan has other CPUs searching other partitions or columns which include the uneven increase in data points (e.g., while waiting for the other CPUs to finish their job with larger volumes). In some examples, the skew of a data or flow partition is the amount by which its size deviates from the average partition size (e.g., column), expressed as a percentage of the largest partition (e.g., column):

Skew of data=(partition size−average partition size)*100/(size of largest partition)

Instances of no or low skew may be where the data points/rows are uniform in frequency and spread, such as where data points are spread evenly in the space and each value (point) has one row.

In some instances, each of skew compensator 232 and cardinality calculator 238 may be referred to as processors, modules or components, and may each be executed on a single processor or separate processors. In some embodiments, they may further include one or more elements for performing any one or combination of steps described in the embodiments. In some instances, the functional components (e.g., skew compensator 232 and cardinality calculator 238) can each be described as a “module” such as a component which is or includes software, hardware, computer logic, another known computer component, a processors, or a combination thereof. In accordance with various embodiments of the present disclosure, the methods described herein (e.g., performed by skew compensator 232 and cardinality calculator 238) may be implemented using a hardware computer system that executes software programs.

In some embodiments, optimizing by optimizer 134 may include using a compiler. As appreciated, different types of compilers exist. A static or compile-time optimizer optimizes a query at the time it is being compiled, thereby avoiding additional overhead at run-time, and potentially assessing a larger number of query execution plans since cost computation is less critical. Dynamic query optimizers, on the other hand, select execution plans at run-time, thereby benefiting from accurate knowledge of run-time resources, host variables and result sized for sub-queries that have already been computed. Just-in-time (JIT) compilation is a form of dynamic query optimizing that occurs before (just in time) run-time.

Executor 240, which may also be referred to as a query engine (such as query engine 132), may perform the execution of the query plan generated and selected by the optimizer 134. The plan itself may be an ordered set of steps used to access data in a relational database management system. Two distinct types of execution plans may exist—an estimated execution plan, in which the plan represents the output from the optimizer 134, and an actual execution plan, in which the plan represents the output from the actual query execution. In one embodiment, the execution plan is changed during actual execution.

The executor 240 may include three primary phases or sub-components: a prepare executor 241, a run executor 242 and an end executor 243. The prepare executor 241 may allocate run-time data structures and prepares for the query execution.

The run executor 242 may execute the query, for example, employing an interpretation and iterator style (not shown). The end executor 243 may free run-time data structures and end the query execution. Results or output of the query may be returned to the requesting client, user or node. The functions executed in each block of executors 240, 241, 242 and 243 can, for example, be implemented using software that runs on a CPU or suitable processor.

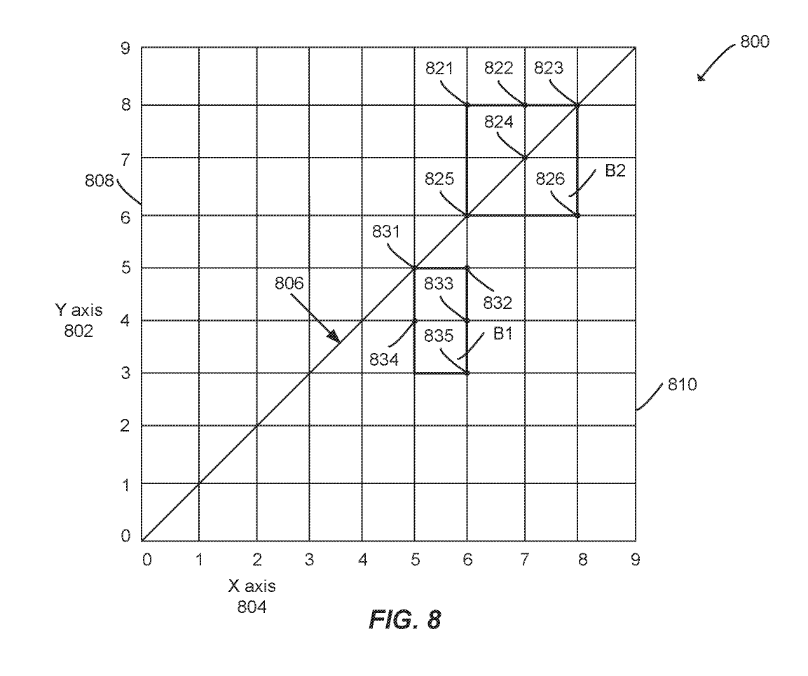

FIG. 3 is a table illustrating actual and estimated selectivity for some example NJMC queries. As illustrated, table 300 includes predicate description field 302, predicate field 304, actual selectivity field 306 and estimated selectivity field 308 for some example NJMC queries that compare l_receiptdate and l_commitdate. For example, table 300 has example NJMC query entry 310 with NJMC predicate description “line items received late” having NJMC predicate “l_receiptdate>l_commitdate”, actual selectivity of 63% and an estimated selectivity of 33% according to one embodiment. Table 300 also has example NJMC query entry 320 with NJMC predicate description “line items received more than 30 days late” having NJMC predicate “l_receiptdate>l_commitdate+30”, actual selectivity of 38% and an estimated selectivity of 33% according to one embodiment. Table 300 also has example NJMC query entry 330 with NJMC predicate description “line items received more than 120 days late” having NJMC predicate “l_receiptdate>l_commitdate+120”, actual selectivity of 0.0005% and an estimated selectivity of 33% according to one embodiment. Table 300 may be used by or part of a process to show the benefits of providing geometric estimated selectivity for NJMC predicates (e.g., see FIG. 3 as compared to FIG. 7).

Embodiments are now discussed using the example NJMC queries and entries of table 300, which include use of SQL and relational query processing concepts like joins and aggregations (e.g., see FIGS. 3-11). These examples may be based on the transaction processing performance benchmark H schema (TPC-H) (e.g., the TPC council defines transaction processing and database benchmarks; and TPC-H is a decision support benchmark) and about a fictional retailer selling different products to customers. The products may be acquired by different suppliers and the sales may be done through orders (orders table). An order may have multiple line-items (“lineitem” table) where each line-item is a specific quantity of a product. Some examples (e.g., see FIGS. 3-4 and 7-8) may use three columns of the “lineitem” table: column “l_orderkey” for order key, column “l_receiptdate” for the actual receipt date of the item and column “l_commitdate” for the committed/promised date of receiving the item. The “orders” table may also be used with just the column “o_orderkey” for the order key that corresponds to one or more line items.

As briefly discussed above, predicate selectivity estimation may be included as part of successful query optimization and its accuracy or lack of accuracy could greatly impact query performance. Some instances consider join predicates like ‘o_orderkey=l_orderkey’ that joins the lineitem and orders table. Other instances extensively model and accurately estimate single column predicates like ‘l_receiptdate<“2016-11-11”’. The estimates of selectivity for join and single column may be mostly based on statistics collected on the base tables. The statistics may, in general, include number of rows of tables and number of distinct values for the columns in the table. To address data skew, a DBMS may compute statistics for equi-depth histograms (e.g., see FIGS. 7, 8 and 10). In some embodiments, the details of statistics collection and selectivity estimation is based on well-known mechanisms.

Some embodiments herein address estimating the selectivity of predicates that are neither joins nor single column (e.g., that instead are NJMC predicates). One example of an NJMC predicate may be entry 310 having predicate ‘l_receiptdate>l_commitdate’ which selects line items that were received late (received after the committed date). In one instance, a conventional commercial database uses a default and fixed selectivity for all such predicates. For example, in a Gauss massively parallel processing (MPP) database (e.g., that does not use the geometric approach to estimate selectivity as described herein), the query optimizer of that database uses ⅓ (33%) as the default estimated selectivity for entry 310 (e.g., see field 306). The selected default selectivity may be an underestimate or overestimate of the actual selectivity for entry 310. In the example shown in FIG. 3, this 33% estimate is far below the 63% actual selectivity for the query. Accordingly, such a 33% estimate may result in the query optimizer choosing a less optimum or less efficient plan to complete the query and use of such a plan can require a larger amount of resource time or “cost” than a more accurate estimate, such as one much closer to the 63% actual selectivity.

, FIG. 3 also illustrates different examples (e.g., entries 310, 320 and 330) of comparisons between l_receiptdate and l_commitdate (e.g., see predicate field 304) with actual selectivity (e.g., actual selectivity field 306) and estimated selectivity (e.g., see estimated selectivity field 308). Similar to entry 310, for an example of a Gauss MPP database, the query optimizer of that database may also use ⅓ (33%) as the default estimated selectivity for entries 320 and 330 (e.g., see field 306) It is also appreciated that other conventional databases (e.g., that do not use the geometric approach to estimate selectivity as described herein) may exhibit similar behavior and problems of using a default and fixed selectivity for some or all NJMC predicates.

Applying a default and fixed selectivity as discussed above could lead a query optimizer to choose an execution plan that is sub-optimal and unnecessarily consumes system resources (e.g., see description of FIGS. 1-2) for the NJMC predicates. This is illustrated by a simple example based on a query (e.g., having an NJMC predicate), in which the query (e.g., “Q1”) retrieves line items and their corresponding orders received more than 120 days late (e.g., see entry 330 of FIG. 3).

Using SQL, the query Q1 may be written as “select * from the lineitem table orders, where l_orderkey=o_orderkey and l_receiptdate>l_commitdate+120.” As discussed above with respect to FIGS. 1-2, in order to execute query Q1, a query optimizer of a query engine may determine an optimum or best plan for executing the query. In one instance, the execution plan selected by the query optimizer is a hash join between line items and order tables. For simplicity, assume that hash join is the best (among other join methods like merge join, nested loop join, etc.) option for the join of the plan selected by optimizer. A hash join is two phase process: a build phase and a probe phase. In the build phase, the join reads rows of a (e.g., best if smaller) table into the memory. It hashes the keys of the rows which will be used for join. Next, in the probe phase the join reads rows of other (e.g., best if larger) table and hashes the keys of the rows which will be used for join. While doing this it checks for the matching rows on hashed keys in the table build in build phase. Thus, with the hash join, the optimizer may have two choices for the hash join depending on which table is the hash table and which is the probe. In some instances, for hash joins to work well, the smaller side of the join should be the hash table and the bigger side should be the probe table.

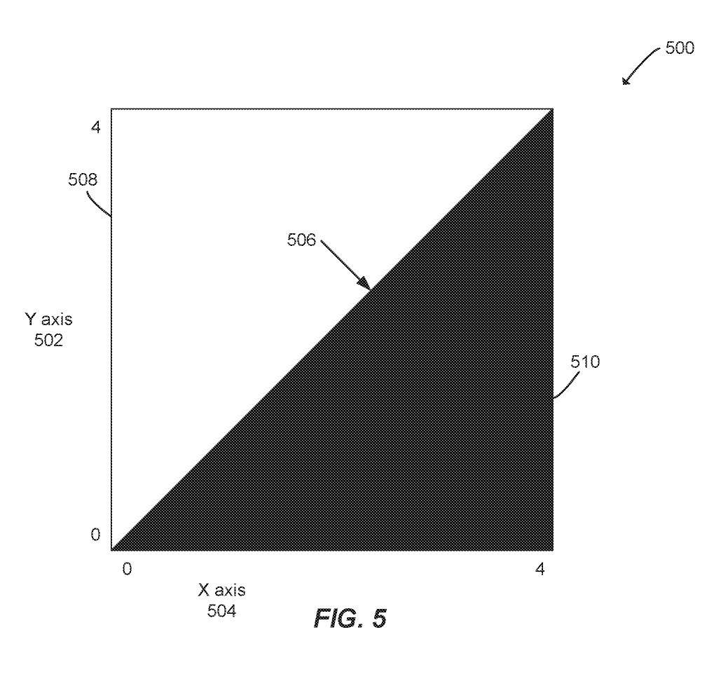

FIGS. 4A-B show two alternative hash join plans for a query having an NJMC predicate. FIG. 4A shows alternative hash join plan 401 for query Q1 having an NJMC predicate “l_receiptdate>l_commitdate+120” (e.g., see entry 330 of FIG. 3). For the example of plan 401, hash join block 402 has hash table 404 and probe 406. Plan 401 may be used to show the disadvantages of not providing geometric estimated selectivity for NJMC predicates.

For discussion sake, we will presume query Q1 has an NJMC predicate executed on a 3 server cluster running Gauss MPP database using transaction processing performance benchmark H schema (TPC-H) data with a scale factor “1000.” A scale factor of 1000 may indicate the raw data size (e.g., 1000 MB) of the data warehouse or table(s). For instance, TPC-H can be run using pre-determined database sizes; referred to as “scale factors” where in this case, the factor is 1000. For TPC-H, some of the tables may grow linearly with the scale factor and are populated with data that is uniformly distributed, and the number of concurrent processes may increase with the scale factor.

The TPC-H data in the examples (e.g., FIGS. 4A-B) have 1.8 billion line items and 450 million orders, as shown by table 404 of FIG. 4A and probe 416 of FIG. 4B. The number of line items that satisfy the NJMC predicate “l_receiptdate>l_commitdate+120” is about 8,000 rows, as shown by probe 406 of FIG. 4A and table 414 of FIG. 4B.

In the disclosed embodiment, plan 401 is a sub-optimal plan in which the “cost” to run the plan 401 is 19 seconds (e.g., as shown in hash join 402). In this example, the plan 401 is sub-optimal since the hash table 404 is built using the bigger data size table of the join-orders (450 million rows) with the probe being the smaller filtered data size table of the join-line item (8000 rows). As discussed above for hash joins, the more efficient plan is typically one that has a smaller data sized build table and a larger sized probe table. Here, plan 401 takes longer (e.g., longer than plan 410) to run since it will first build hash table 404 with 450 million rows, which is a much larger data build than the join of 8000 rows.

FIG. 4B shows alternative hash join plan 410 for query Q1 having an NJMC predicate “l_receiptdate>l_commitdate+120” (e.g., see entry 330 of FIG. 3), such as may be provided by the geometric approach herein or by optimizer 134. For the example of plan 410, hash join block 412 has hash table 414 and probe 416. Plan 410 may be used to show the advantages of providing geometric estimated selectivity for NJMC predicates (e.g., the geometric approach, such as compared to plan 401).

In the disclosed embodiment, plan 410 is the optimal plan (e.g., more optimal as compared to plan 401) since the “cost” to run the plan 410 is 3 seconds (e.g., as shown in hash join 402). In this example, the plan 410 is optimal since the hash table 414 is built using the smaller filtered data size table of the join-line item (8000 rows) with the probe being the bigger data size table of the join-orders (450 million rows). As discussed above for hash joins, the more efficient plan is typically one that has a smaller data sized build table and a larger sized probe table.

However, in the examples above (e.g., FIGS. 4A-B), a Gauss MPP database query optimizer (e.g., one that does not use the geometric approach to estimate selectivity as described herein) may select the sub-optimal plan 401 for execution of the query Q1 based on that query optimizer's estimated selectivity 308 of entry 330 for the NJMC predicate 304 being 33%, where 33% represents the default and fixed selectivity. This 33% default and fixed selectivity estimate results in the query optimizer calculating that there are 1.8 billion (TPC-H data has 1.8 billion line items)×0.33 (default selectivity) line items having data indicating a late delivery of the product (e.g., as compared to the commitment date data), which is equal to 600 million late line items (e.g., cardinality for this NJMC predicate part of the join). When the Gauss MPP database optimizer calculates that 600 million late line items (cardinality of NJMC predicate which will be one part of the join) is higher than the 450 million orders (cardinality of order which will be another part of the join), it may select to put the lower number (450 million orders-orders) as the hash table and the higher number cardinality of the NJMC predicate (calculated as having 600 million late line items based on 33% default selectivity) as the probe.

As seen in the example of FIGS. 4A-B, the selection of plan 401 by a Gauss MPP database optimizer will lead to a 19 second time for the hash join which is more than 6 times longer than the 3 second time should the query optimizer (e.g., optimizer 134 using a geometric solution) select plan 410. That is, by virtue of selecting the wrong plan, a query optimizer's calculation using the 33% default and fixed selectivity leads to a larger cost, less efficient, “bad” plan that requires more system resources.

In one embodiment, to help ensure that the query optimizer selects the appropriate (more efficient) plan, the query optimizer may estimate selectivity of NJMC predicates of a multi-column table (MCT) of a database query by representing the full space and NJMC predicate spaces as polyhedrons.

According to examples described herein, FIG. 4A is a hypothetical bad solution of query optimizer selection of a plan for a query including an NJMC predicate, such as based on using a Gauss MPP DB optimizer which estimates selectivity of an NJMC predicate as a static 33%. Then, FIG. 4B is a hypothetical good solution for the same query instance, the good solution based on using optimizer 134 with estimator 136 which has the geometric solution embodiments described herein.

In the case of linear NJMC predicates, the predicate can be represented as a1*x1+a2*x2+ . . . <=c which may be described as a Diophantine equation (where x is the array; a1, a2, . . . an are integers; and 1, 2, . . . n is the loop variable), that has an integer solution x1, x2, . . . , xn if the greatest common divisor (a1, a2, . . . , an) divides c. However, a predicate represented in this form may be considered broad for database NJMC predicates. Accordingly, a more common representation of an NJMC predicate is composed of two variables, such as l_receiptdate>l_commitdate, which may be normalized to the above a1*x1+a2*x2+ . . . <=c form as l_commitdate−l_receiptdate<0. In some instances, the a1*x1+a2*x2+ . . . <=c form above covers equalities (e.g., =) and in-equalities (e.g., < and >), such as due to the following interpretations of the operators:
= is transformed to <= and >=
< > is transformed as complement of =
>= is equivalent to <=. For example, x−y>=0 is equivalent to y−x<=0
> is transformed as >=. For example, x−y>1 is transformed to x−y>=2. This is true since all the columns are assumed to have discrete values. This transformation is similar from < to <=.

In some instances, representing the full space and NJMC predicate spaces as polyhedrons of an NJMC predicate of a multi-column table (MCT) of a database query can be based on representing “normalized” NJMC predicates and the full space of MCTs of the query as bounded polyhedron or polytope. In some instances, a polyhedron is a 3-dimensional example of the more general polytope in any number of dimensions. In some cases, a polyhedron (plural polyhedra or polyhedrons) may be a solid in three dimensions with flat polygonal faces, straight edges and sharp corners or vertices. In some instances, a convex polyhedron is the convex hull of finitely many points, not all on the same plane. Cubes and pyramids may be examples of convex polyhedra.

An example of a simple definition of polyhedron in geometry is an n-dimensional object defined by intersecting polygons. In some cases, in the 2-dimensional space a polyhedron can be interpreted by rectangles and triangles. According to some embodiments, we interpret NJMC predicates as bounded polyhedron (polytopes) with the MCT columns as the geometric dimensions and the MCT rows as points. In some instances, the knowledge bounds of this interpretation is reasonable since it is not difficult to determine the bounds of the MCT columns involved in the NJMC predicate. In some instances, the bounds of the MCT columns can be found from “analyze” or statistics collection. In some embodiments, the details of finding the bounds of the MCT columns from “analyze” or statistics collection is well-known in the field.

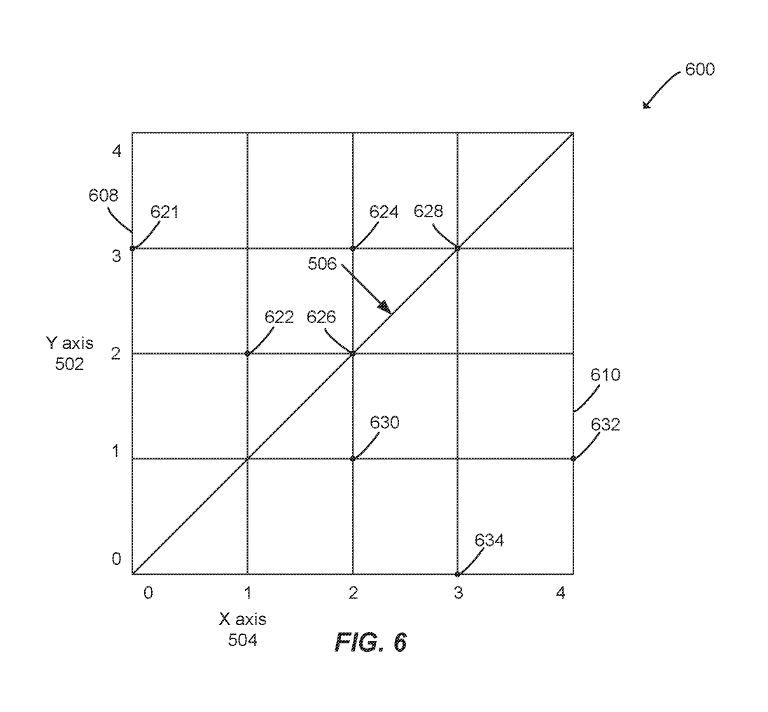

FIG. 5 is an example of the geometric representation showing an NJMC predicate. In particular, FIG. 5 shows geometric representation (e.g., graph) 500 showing the NJMC predicate “x>=y” in a table (e.g., “T1”), where both x and y have a range between 0 and 4. Representation 500 shows vertical Y axis 502 having values from 0 to 4; and horizontal X axis 504 having values from 0 to 4. The line or locations where x=y is represented by line 506. The shaded triangle 510 has an area that represents the predicate “x>=y” (and may include line 506, though for calculating the area of the predicate space, the line x=y may be removed from this area′ calculation since it may not add to or have any impact on the area of the predicate space x>=y). The unshaded area 508 defines “x<y,” which is not part of the predicate. Thus, the full (e.g., total) space is the area of triangle 508 plus the area of triangle 510 (and the area of line 506, which may have no impact on the full space area). Also, the predicate space is the area of triangle 510 (and the area of line 506, which may be removed from this area′ calculation since it may have no impact on the predicate space area). Representation 500 may be used as or part of a process to provide geometric estimated selectivity for NJMC predicates, as explained below.

In some instances, with geometric representation of the full space and NJMC predicate space as polyhedrons (e.g., representation 500 having them in two dimensional—2D space), one could estimate the selectivity of an NJMC predicate (e.g., NJMC predicate “x>=y”) of the query by computing the percentage of the size of the NJMC predicate space relative to the total size of the space for all the columns. In some cases, each size can be represented by or as a hyper-volume in the n-dimensional space of the representation. In representation 500, each size can be the area in the 2D-space of representation 500 (hyper-volume in the n-dimensional space of representation 500). In FIG. 5, the area of the shaded rectangle 510 (e.g., space for NJMC predicate “x>=y”) is slightly over 50% of the total area (e.g., of the full space=area 508+area 510) and can be used to estimate the selectivity of the predicate space “x>=y” of the query. In one example, based on representation 500, if table T1 has 8 rows, then the expected number of rows is 4 for a SQL query we will call query 2 (e.g., “Q2”) that is “select* from T1 where x>=y”.

In some cases, each size (e.g., of the full space and NJMC predicate space as polyhedrons spaces of the query) can be represented by or as number of integer points in the n-dimensional space of the representation. In representation 500, each size can be the number of integer points in the 2D-space of representation 500 (discrete value mappings of the database column values of representation 500). In some cases, using size as the number of integer points is more intuitive for database columns since they have discrete values that map to integers more naturally than the continuous real domain (e.g., of hyper-volumes). In some examples, the actual database (e.g., tables and columns) may have duplicate rows which implies duplicate points in the polyhedron representations of the predicate and/or full spaces. In some embodiments, there is no simple geometric representation of duplicate points in space and a polyhedron sufficiently represents database points for uniform distribution with no skew in terms of number of rows per column value and in terms of the spread of the points in the full and predicate spaces.

In some instances, selectivity is computed (e.g., estimated) as P1/P2 where P1 is the number of points of the polyhedron defined by the NJMC (e.g., NJMC predicate) bounds, and P2 is the number of points of the polyhedron defined by the (e.g., full or total) bounds (rectangle, prism or hyper rectangle) of the query. It is appreciated that numerous well-known algorithms exist in geometry and lattice theory that can be used to find the number of points in a polyhedron and that can be used to compute P1 and P2.

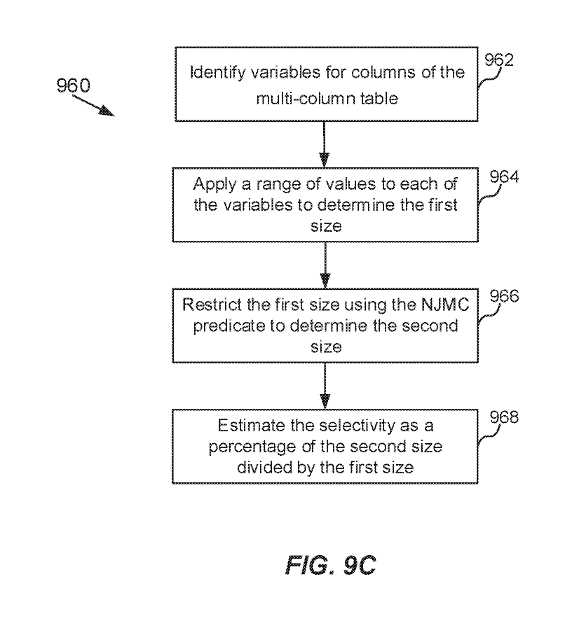

In some cases, the geometric approach described for FIG. 5 can be performed or described by the processes of FIGS. 9A (e.g., at 910, 920 and 930), 9B and/or 9C described below. In some examples, an example of a simple solution (e.g., algorithm) to find the number of points in the full and predicate space polyhedrons and to compute P1 and P2 can be written for the 2-dimensional case (e.g., of representation 500) using rectangles and triangles (e.g., see FIGS. 5, 6, and 8).

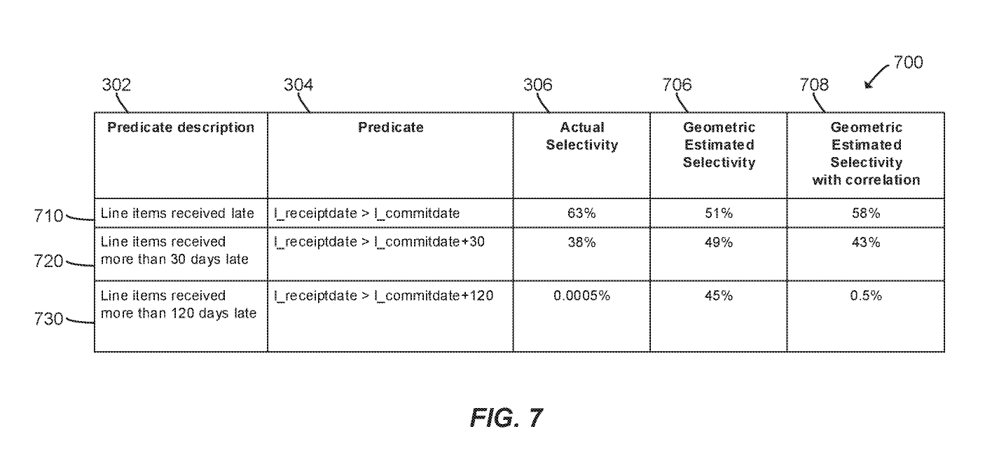

FIG. 6 is an example of the geometric representation showing an NJMC predicate. In the illustration, the figure shows an example of geometric representation (e.g., graph) 600 with an NJMC predicate “x>=y”. In one embodiment, representation 600 is used to explain an example of integer points representing the sizes of polyhedrons for selectivity estimation for Q2 against T1, defined above, for representation 500 of FIG. 5. In this example, representation 600 shows the selectivity estimation using the number of points in the full and predicate space polyhedrons for a query having NJMC predicate “x>=y” in T1, where both x and y have a range between 0 and 4 for selectivity estimation using the number of integer points in the full and predicate spaces.

Representation 600 shows vertical Y axis 502 having values from 0 to 4; and horizontal X axis 504 having values from 0 to 4. The line or locations where x=y is represented by line 506. The lower right triangle 610 (e.g., covering the same area as dark triangle 510 of FIG. 5) has an area that represents the predicate “x>=y” and includes line 506. In this example, the actual number of data rows/points in the predicate space is 5 which are points 626, 628, 630, 632 and 634 at (x,y) coordinates: (2,1), (2,2), (3,0), (3,3) and (4,1), respectively. The upper left triangle 608 (e.g., covering the same area as unshaded area 508 of FIG. 5) defines “x<y” which is not part of the predicate. In this example, the actual number of data rows/points in this non-predicate space is 3 which are points 621, 622 and 624 at (x,y) coordinates: (0,3), (1,2) and (2,3), respectively. Thus, the full (e.g., total) space is the area of triangle 608 plus the area of triangle 610, which has 8 total points (3+5 points). Representation 600 may be used as or part of a process to provide geometric estimated selectivity for NJMC predicates.

Representation 600 also shows the total or full space of the query defined by the polyhedron (x>=0 and x<=4 and y>=0 and y<=4) which has 25 points, each point defined where an integer value of x (e.g., 0, 1, 2, 3 and 4) intersects an integer value of y (e.g., 0, 1, 2, 3, and 4) in triangle 608 and 610. The polyhedron space of the query for the NJMC predicate x>=y is (x>=0 and x<=4 and y>=0 and y<=4 and x>=y) which covers 15 points, each point defined where an integer value of x (e.g., 0, 1, 2, 3, and 4) intersects an integer value of y (e.g., 0, 1, 2, 3 and 4) in triangle 610 and including line 506. In this example, counting the points of the full and predicate space, the selectivity of “x>=y” is estimated to be 15/25 which is 60%. Also, based on this estimation, the number of rows satisfied by Q2 in T1 (e.g., cardinality of points of Q2 against T1), in this example is estimated to be the number of rows of the full space (8 total data points in T1) times the estimated selectivity (e.g., 60%) which is 8×0.6=4.8. Thus, we have an estimated count of 4.8 data points that satisfy that predicate for T1.

In this example, the actual number of data rows/points in the predicate space is 5. These data points/rows are at (x,y) coordinates: (2,1), (2,2), (3,0), (3,3) and (4,1). Thus, the estimated count of 4.8 rows/points is nearly approximate to the actual 5 data rows/points in representation 600. For discussion, in representation 600, the data points/rows are uniform in frequency and spread, such as where data points are spread evenly in the space and each value (point) has one row. In some cases, the geometric approach described for FIG. 6 can be performed or described by the processes of FIGS. 9A (e.g., at 910, 920 and 930), 9B and/or 9C, as described below. In some cases, the geometric approach can be enhanced (e.g., optionally) to handle skewed cases (frequency and spread skew) is discussed later in the document (e.g., see FIGS. 7, and 9-10 below).

According to some embodiments, the geometric approach of estimating selectivity of an NJMC predicate based on representing the full space of the table and the NJMC predicate space as a polyhedrons, and then using the proportion of the sizes of the predicate to the full polyhedrons to estimate selectivity, assumes uniformity of frequency of possible data values and uniformity of data spread.

Some embodiments of the geometric approach work well for non-skewed data and work well after proposed embodiments for correcting or compensation for data skew in the MCT for the skewed data cases (e.g., in the MCT) and an improvement over existing solutions for such skew. Additionally, in some instances, the geometric approach can be extended to handle or compensate for skew in a natural way. For discussion sake, in FIG. 7 below, an extension of compensating for skew is described by revisiting the TPC-H example of NJMC predicates of fields 302 and 304 of the cases l_receiptdate>l_commitdate+c (e.g., see at least FIGS. 3-4) which are repeated in FIG. 7.

FIG. 7 is an example table illustrating actual selectivity, geometric estimated selectivity and geometric estimated selectivity with a correlation constraint to compensate for skew for queries having NJMC predicates. Table 700 shows three example rows, each having a predicate description field 302, predicate field 304, actual selectivity field 306, geometric estimated selectivity field 706 and geometric estimated selectivity with correlation field 708 for queries that compare l_receiptdate and l_commitdate. For example, table 700 has example NJMC query entry 710 with NJMC predicate description “line items received late” having NJMC predicate “l_receiptdate>l_commitdate”, actual selectivity of 63%, geometric estimated selectivity of 51% and geometric estimated selectivity with correlation of 58% according to one embodiment. Table 700 also has example NJMC query entry 720 with NJMC predicate description “line items received more than 30 days late” having NJMC predicate “l_receiptdate>l_commitdate+30”, actual selectivity of 38%, geometric estimated selectivity of 49% and geometric estimated selectivity with correlation of 43% according to one embodiment. Table 700 also has example NJMC query entry 730 with NJMC predicate description “line items received more than 120 days late” having NJMC predicate “l_receiptdate>l_commitdate+120”, actual selectivity of 0.0005%, geometric estimated selectivity of 46% and geometric estimated selectivity with correlation of 0.5% according to one embodiment. Table 700 may be used as or part of a process to show the benefits of providing geometric estimated selectivity for NJMC predicates for NJMC predicates (e.g., see FIG. 3 as compared to FIG. 7).

For purposes of discussion, the examples that follow are discussed using (1) the predicate descriptions of field 302, predicates of field 304 and actual selectivity of field 306 of the example NJMC queries of table 300 from FIG. 3; (2) table 700 showing side by side the selectivity 306, 706 and 708 for the three cases of late delivery of late items of the examples from FIG. 3, such as where example NJMC query entries 710, 720 and 730 have the same predicate descriptions of field 302, predicates of field 304, and actual selectivity of field 306 as example NJMC query entries 310, 320 and 330, respectively; and (3) the full space of example entries 710, 720 and 730 is defined by the date ranges of the l_receiptdate and l_commitdate and the bounds are listed below with date format as ‘yy-mm-dd’:

l_receiptdate>=‘92-01-03’ and l_receiptdate<=‘98-12-31’ and l_commitdate>=‘92-01-31’ and l_commitdate<=‘98-10-31’

In the above examples, the geometric estimated selectivity solution (e.g., field 706) of these example entries 310, 320 and 330 are reasonably accurate (e.g., close to actual selectivity) for the NJMC predicate “l_receiptdate>l_commitdate”, except that the error margin (e.g., the difference between field 306 and field 706) increases for more days of being late (e.g., see the difference between field 306 and field 706 for entry 330). In one embodiment, the reason for the increase in error margin may be that the l_receiptdate and l_commitdate data is skewed (e.g., data spread skew) for situations where the majority of the line items are received plus or minus a few days of the committed date. In other embodiments, the actual data shows that (e.g., is skewed such that) all line items are received as early as 88 days before the committed date and as late as 121 days. In such an example, the skew of the actual data showing that (e.g., is skewed such that) all line items are received as early as 88 days before the committed date and as late as 121 days can be represented as a correlation constraint (e.g., to compensate for the skew) “l_receiptdate>=l_commitdate−88 and l_receiptdate<=l_commitdate+121”. In some embodiments, when a correlation constraint (e.g., integrity constraint) applies to a table, all data in the table must conform to the corresponding rule of the correlation constraint. In some examples, a SQL statement (e.g., applying a correlation constraint) can be used to modify data in the table to create new/modified data that satisfies the correlation constraint. In some instances, a correlation constraint is a data correlation that expresses the constraints between values of different fields in one or more records or columns. In some embodiments, such constraints can easily be computed either exactly or approximately. In some instances, such constraints can be used to improve the geometric estimated selectivity solution to handle skew, such as to compensate (e.g., correct) for data spread skew or for frequency of data value skew. In this example, with the knowledge of the above constraint the full space can be defined as (e.g., where the italicized text below is the skew compensation for the full space):

F=l_receiptdate>=‘92-01-03’ and l_receiptdate<=‘98-12-31’ and l_commitdate>=‘92-01-31’ and l_commitdate<=‘98-10-31’ and l_receiptdate>=l_commitdate−88 and l_receiptdate<=l_commitdate+121

The late items (e.g., NJMC predicate space searched for in a query having an NJMC predicate) can be represented as the full space and adding (e.g., as constrained by) the corresponding NJMC predicate (e.g., of field 304). For example, line items that are late more than 120 days (e.g., the predicate of entry 730) can be defined by the polyhedron (e.g., where the italicized text below is the full space):

l_receiptdate>l_commitdate+120 and l_receiptdate>=‘92-01-03’ and l_receiptdate<=‘98-12-31’ and l_commitdate>=‘92-01-31’ and l_commitdate<=‘98-10-31’ and l_receiptdate>=l_commitdate−88 and l_receiptdate<=l_commitdate+121

This can simplified to:

l_receiptdate>l_commitdate+120 and l_receiptdate>=‘92-01-03’ and l_receiptdate<=‘98-12-31’ and l_commitdate>=‘92-01-31’ and l_commitdate<=‘98-10-31’ and l_receiptdate<=l_commitdate+121

Applying the geometric estimated selectivity solution using the modified (e.g., skew compensated) polyhedron for the full space and NJMC space, as discussed above, results in P1=513,990 and P2=2405, which implies (e.g., estimates) a selectivity of 2405/513,990=0.5%. However, in one example, geometric estimation of the selectivity of the entire geometric area 800, without applying a correlation constraint as explained herein (and/or geometric solution as described below) will result in an estimated selectivity of 46% (e.g., see field 706 of entry 730). In this example, 46% may be a geometric estimation of the selectivity of the entire geometric area 800, calculated by counting the number of points in the full space, counting the number of the points in the predicate space, and dividing the number in the predicate space by the number in the full space (e.g., which will=46%). This example of this geometric estimation can be performed using variable “X” to represent column “l_receiptdate” and variable “Y” to represent column “l_commitdate”. In this example, the range of the values l_receiptdate>=‘92-01-03’ and l_receiptdate<=‘98-12-31’ and l_commitdate>=‘92-01-31’ and l_commitdate<=‘98-10-31’ can be mapped to an integer range of X>=1 and X<=2554 and Y>=28 and Y<=2493. These values can be found by mapping the lowest date to 1 and computing the other dates from the lowest date, using number of days difference. For example, mapping to an integer range of X>=1 (representing X>=‘92-01-03’ as lowest date, day 1) and X<=2554 (representing X<=‘98-12-31’ which is 2554 days after ‘92-01-03’) and Y>=28 (representing Y as >=‘92-01-31’ which is 28 days after the lowest date ‘92-01-03’) and Y<=2493 (representing Y<=‘98-10-31’ which is 2493 days after ‘92-01-03’). Based on these values, the full space is 6,298,164 points, which is calculated from multiplying the points in the integer ranges above as follows 2554*(2493−28+1). Also, based on these values, the NJMC predicate space calculated by adding the predicate X>Y+120 which is X>=Y+121 to the full space (e.g., as a constraint to the full space). Then, Y+121 part of the predicate can be mapped to a variable “Z” so we have a mapped predicate of X>=Z. Here, Z (e.g., Y+121) has an integer range that is [149, 2614] (e.g., Y>=28+121, Y<=2493+121) which implies an integer range intersection between Z and X (where X has an integer range that is [1, 2554]) of [149, 2554]. That is, the Z range of [149, 2614] and X range of [1, 2554] overlap for an integer range intersection between Z and X of [149, 2554] since 149>1 and 2554<2614. Also, in the [149, 2554] overlap range, there are total 2406*2406 points (e.g., (2554−149+1)*1 for the X overlap of Z, and *2 (again) for the Z overlap of X), which is equal to 5788836 points. This implies 5788836/2+2406/2 points for the mapped predicate X>=Z which is 2895621 points. That is X>=Z can be calculated as X>Z which is ½ of the area of the X and Z range overlap (e.g., ½ of the 2 dimensional area where X and Z have the same dates/points, or ½ of 2406*2406 points), plus X=Z which is ½ of the total points (e.g., ½ of where X and Z have the same dates/points, or ½ of 2406 points). Note that points outside the range do not meet X>=Z. In this example, we can estimate selectivity as the predicate spaces points divided by the full space points, or by calculating the percent of P1/P2=2895621/6298164=45.97%. Here, geometric estimation without applying a correlation constraint as explained herein (and/or geometric solution as described below)=46%. It can be appreciated that the geometric estimated selectivity solution using the modified (e.g., skew compensated) polyhedron for the full space and NJMC space of 0.5% is significantly more accurate than the 46% from geometric selectivity of the entire geometric area 800, without applying a correlation constraint as explained herein (and/or geometric solution as described below). In other words, the skew compensated full space (P1=513,990) and skew compensated predicate space (P2=2405) can be used to calculate geometric estimated selectivity with correlation field 708 of entry 730 (of 2405/513,990=0.5%) which is significantly more accurate than the geometric estimated selectivity (e.g., without correlation) field 706 of entry 730 (46%) when compared to the actual selectivity in entry 730 (0.0005%).

In some instances, any or all of the values estimated in geometric estimated selectivity with correlation field 708 of entries 710, 720 and 730 are accurate enough (e.g., when compared to the actual selectivity field 306 for each entry) to get the optimal plan, such as described before for Q1 (e.g., see FIGS. 4A-B). In some cases, compensating for skew as described for FIG. 7 can be performed or described by the processes of FIGS. 9A (e.g., at 905) and/or 10, described below.

According to embodiments, “equi-depth histograms” (e.g., equi-depth multi-dimensional histograms) is a structure that can improve the geometric estimated selectivity solution for skewed cases (frequency or spread skew as noted above). In some instances, equi-depth histograms is another additional structure that is used in addition to correlation constraints (e.g., see FIG. 7) to compensate or correct data skew. In other instances, equi-depth histograms or correlation constraints are used separately. In still another instance, neither are used to compensate or correct for skew.

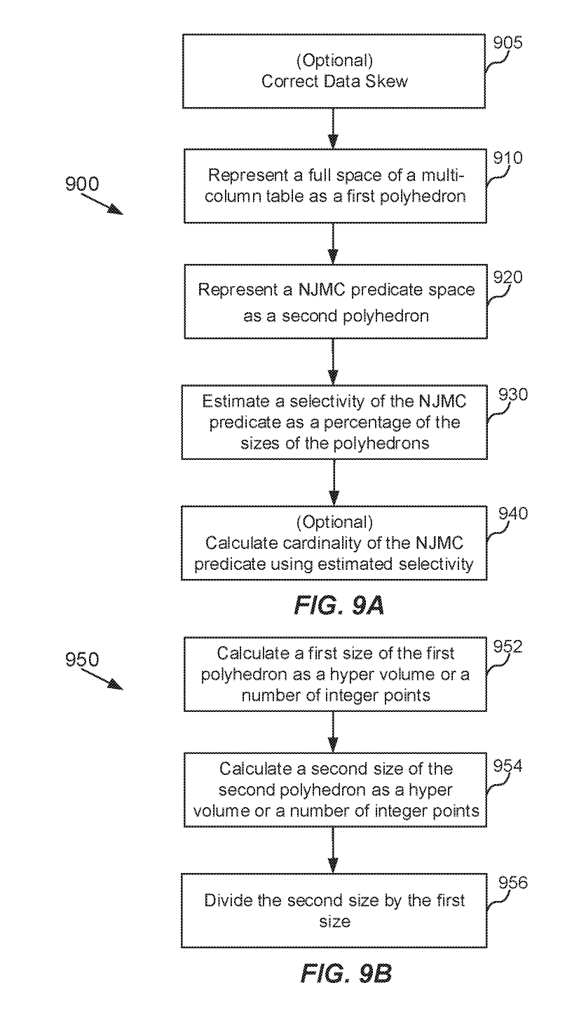

FIG. 8 is an example of the geometric representation showing an NJMC predicate having equi-depth histograms with two buckets. The depicted example shows a geometric representation (e.g., graph) 800 with the NJMC predicate “x>=y having equi-depth multi-dimensional histograms within two buckets B1 and B2. In some instances, representation 800 may be used to explain an example of using equi-depth multi-dimensional histograms. In some instances, these equi-depth multi-dimensional histograms may be used to compensate (e.g., correct) skew in instances of integer points representation of the sizes of polyhedrons for selectivity estimation for a query having an NJMC predicate against a table. In this example, representation 800 may be used to explain selectivity estimation using the number of points in the full and predicate space polyhedrons for a query having NJMC predicate “x>=y” in T1, where both x and y have a range between 0 and 9 for selectivity estimation using the number of points.

Representation 800 shows vertical Y axis 802 having values from 0 to 9, and horizontal X axis 804 having values from 0 to 9. The line or locations where x=y is represented by line 806. The lower right triangle 810 (e.g., covering the area of a triangle) has an area that represents the predicate “x>=y” and includes line 806. In this example, the actual number of data rows/points in the predicate space is 9 which are points 823, 824, 825, 826, 831, 832, 833, 834 and 835 at (x,y) coordinates: (8,8), (7,7), (6,6), (8,6), (5,5), (6,5), (5,4), (6,4) and (6,3), respectively. The upper left triangle 808 (e.g., covering the area of a triangle) defines “x<y” which is not part of the predicate. In this example, the actual number of data rows/points in this non-predicate space is 2 which are points 821 and 822 at (x,y) coordinates: (6,8) and (7,8), respectively. Thus, the full (e.g., total) space is the area of triangle 808 plus the area of triangle 810, which has 11 total points (9+2 points). Representation 800 may be used as or part of a process to provide geometric estimated selectivity for NJMC predicates of a query, where equi-depth multi-dimensional histograms are used to correct skew.

In some embodiments, equi-depth multi-dimensional histograms is basically a partitioning (e.g., into partitions or “buckets”) of the space based on the number of rows. In some instances, creating an equi-depth multi-dimensional histograms includes selecting one or more partitions of the full space polyhedron based on the number of rows of the table. In some examples, selecting the partitions may be or include selecting a number of partitions, where each partition has an equal or smallest amount of difference possible in the number of rows (e.g., data points) in each of the partitions. In some instances, each partition will be a contiguous area. In some instances, each partition will optionally be rectilinear. In the example of FIG. 8, selecting the partitions may include selecting two partitions, where one partition has 6 and the other has 5 number of rows.

As noted above, FIG. 8 illustrates two equi-depth histograms at or within the two buckets B1 and B2. In this example, bucket B1 is at or exists at x>=5 and x<=6, and y>=3 and y<=5 and has 5 rows of data from the table on which the query having the NJMC predicate will be performed. Bucket B1 has a row of data at each of (x,y) coordinates: (5,5), (6,5), (5,4), (6,4) and (6,3). In this example, bucket B2 is at or exists at x>=6 and x<=8 and y>=6 and y<=8 and has 6 rows of data from that table. Bucket B2 has a row of data at each of (x,y) coordinates: (6,8), (7,8), (8,8), (7,7), (6,6) and (8,6).

In some embodiments, applying a geometric estimated selectivity solution for the NJMC predicate x>=y of a query without the histogram knowledge (e.g., without using equi-depth histograms or any other process to compensate for skew) results in geometric estimated selectivity of 55% which is based on the entire geometric area 800, without applying a correlation constraint as explained herein and/or geometric solution as described herein (e.g., see FIG. 5). In this example, selectivity may be estimated as the predicate space of triangle 810, which has 55 possible data points over the full space of the table, which has 100 total possible data points (from the 10 by 10 rectangle). An example calculation of this geometric estimated selectivity include the full space having 100 points and the predicate space of x>=y covers the lower triangle 810 and includes the x=y line 806 adding to more than 50% of the point count of the full space of 100 points. For example, the point count for triangle 810 is 45 points, and including line 806 (10 points) is equal to 55 points. The point count for triangle 808 is 45 points. Thus, in this example calculation, this geometric estimated selectivity is 55/100 or 55%. Here, the 55% geometric estimated selectivity solution without the histogram knowledge (e.g., without using equi-depth histograms or any other process to compensate for skew) has a big margin error compared to actual selectivity of 82% (e.g., FIG. 8 shows 9 points within triangle 810 and including line 806, and 2 points within triangle 808 and not including line 806; thus showing actual selectivity of 9/11 or 82%).

In this example, the actual selectivity is the 9 actual data points of the NJMC predicate space (e.g., for predicate x>=y) over the total 11 actual data points of the full space. In some instances, the margin of error in geometric estimated selectivity is significantly less (e.g., reduced) if we apply the geometric estimated selectivity solution (e.g., see FIG. 5-6, and field 706 of FIG. 7) to each bucket of the equi-depth histograms. In some instances, the difference between the geometric estimated selectivity and actual selectivity is reduced by separately applying the geometric estimated selectivity solution to each bucket of the equi-depth histograms, and then adding the results from separately applying the solutions.

In this example, when the geometric estimated selectivity solution is applied to bucket B1, all 6 data points of the data in bucket B1 satisfy the NJMC predicate x>=y. So, counting the points of the full and predicate spaces, the selectivity of bucket B1 for “x>=y” is estimated to be 6/6 which is 100%. Also, in the example and based on this estimation, the number of rows satisfied by the predicate (e.g., cardinality of points for the predicate against the table for bucket B1) is estimated to be the number of rows of the full space for bucket B1 (5 data points in B1) times the estimated selectivity (100%) which is 5×1.0=5. Thus, we have a count of 5 data points that satisfy that predicate for bucket B1 (e.g., B1 completely satisfies the predicate portion or constraint x>=y of the full space).

When the geometric estimated selectivity solution is applied to bucket B2 of this example, we see that bucket B2 is 3 by 3 which has a full space of 9 points (e.g., (6,6), (6,7), . . . (8,8)). The predicate space of x>=y (e.g., the x>=y portion or constrained full space) in this example is 6 points (e.g., (6,6), (7,6), (7,7), (8,6), (8,7) and (8,8)). Here, 6 of the 9 possible data points of the data in bucket B2 satisfy the NJMC predicate x>=y. So, counting the points of the full and predicate spaces, the selectivity of bucket B2 for “x>=y” is estimated to be 6/9 which is 66%.

Additionally, in the example and based on this estimation, the number of rows satisfied by the predicate (e.g., cardinality of points for the predicate against the table for bucket B2) is estimated to be the number of rows of the full space for bucket B2 (6 data points in B2) times the estimated selectivity (66%) which is 6×0.66=4. Thus, we have a count of 4 data points that satisfy that predicate for bucket B2.

In this example, adding the results from separately applying the solutions to buckets B1 and B2, overall, the geometric estimated selectivity solution estimate (with equi-depth multi-dimensional histograms) is 9 rows which matches the actual 9 rows.

According to embodiments, the full space of a MCT may be represented as one polyhedron having one dimension for each column of the multi-column table (e.g., 27 occurrences with respect to FIG. 8), and the NJMC predicate space may be represented as another polyhedron having one dimension for each column of a predicate space determined by applying an NJMC predicate to the multi-column table. The selectivity of the NJMC predicate may be estimated by computing a percentage of the size of the NJMC predicate space polyhedron to the size of the full space polyhedron.

Embodiments described herein provide an approach on selectivity estimation for NJMC predicates. Some instances leverage the field of geometry and lattice theory. In some embodiments, NJMC predicates are represented as bounded polyhedron and size estimation is used to compute selectivity. In some instances, this representation and estimation works well for non-skewed cases and can be enhanced using the same approach for skewed cases by considering additional constraints and/or applying the geometric solution to equi-depth multi-dimensional histograms.

FIG. 9A is a flow diagram of a process for performing a portion of query optimization according to example embodiments. More specifically, FIG. 9A shows process 900 for performing a portion of query optimization. In some cases process 900 includes performing skew compensation, selectivity estimation and cardinality calculation as described for compensator 232, estimator 136 and calculator 238 of optimizer 134 of FIGS. 1-2. Process 900 may be processes performed by engine 132 or optimizer 134 (and include processes performed by estimator 136), or any other component in the system as described herein.

At 905, data skew is optionally corrected or compensated for. In some instances, correcting includes descriptions provided for compensator 232, or may be performed according to the descriptions provided herein of FIG. 7, 8 or 10, or alternatively of FIGS. 7 and 8. The correcting may be performed, for example, by compensator (e.g., module) 232, or any component in the system as described above.

At 910, a full space of a multi-column table (MCT) is represented as a first polyhedron. This polyhedron may have one dimension for each column of the multi-column table. In some instances, representing the full space in 910 may include defining the first polyhedron as a first n-dimensional, bounded polyhedron based on statistical calculations or estimations used on a plurality of columns of the multi-column table.

At 920, a non-join multi-column (NJMC) predicate space is represented as a second polyhedron. This polyhedron may have one dimension for each column of a predicate space determined by applying an NJMC predicate to the multi-column table. In some instances, representing the NJMC predicate space in 920 may include defining the second polyhedron as a second n-dimensional, bounded polyhedron based on statistical calculations or estimations used on a plurality of columns of the NJMC predicate space that are a subset of the plurality of columns of the multi-column table.

At 930, a selectivity of the NJMC predicate is estimated by computing a percentage of a second size of the second polyhedron to a first size of the first polyhedron.

In some instances, 910, 920 and 930 may be performed according to the descriptions provided for estimator 136. In some instances, 910, 920 and 930 may be performed according to the descriptions provided ff FIG. 5, 6, 7 or 8; or alternatively off FIGS. 7 and 8. 910, 920 and 930 may be performed according to the descriptions of estimator (e.g., module) 136. In some instances, 910, 920 and 930 may be described as a computer-implemented method for computing a selectivity estimation of a database query.

At 940, cardinality of the NJMC predicate is optionally calculated using the estimated selectivity. In some instances, this calculating may be performed according to the descriptions provided of calculator 238. In some instances, this calculating may be performed according to the descriptions provided of FIG. 5, 6, 7 or 8; or alternatively of FIGS. 7 and 8. This calculating may be performed by calculator (e.g., module) 238, or any component in the system as described above.

In some instances, process 900 includes 910, 920 and 930. In other instances process 900 includes 905, 910, 920 and 930. In still another instance, the process 900 includes 910, 920, 930 and 940. In yet another instance, the process includes 905, 910, 920, 930 and 940.

FIG. 9B is a flow diagram of a process for performing geometric selectivity estimation according to example embodiments. More specifically, FIG. 9B shows process 950 for performing geometric selectivity estimation. In some cases process 950 includes selectivity estimation performed according to the descriptions of estimator 136 of optimizer 134 of FIGS. 1-2, or any other component in the system as described herein. In some instances, process 950 is performed as part of 910-930 of process 900. In some instances, process 950 is performed as a replacement of 910-930 of process 900.

At 952 a first size of a first polyhedron is calculated as one of a hyper volume in n-dimensions, or a number of integer points of the first polyhedron, where the first polyhedron is a full space of a multi-column table (MCT). In some examples, this polyhedron may have one dimension for each column of the multi-column table.

At 954, a second size of a second polyhedron is calculated as one of a hyper volume in n-dimensions, or a number of integer points of the second polyhedron, where the second polyhedron is a non-join multi-column (NJMC) predicate space of the multi-column table (MCT). This polyhedron may have one dimension for each column of a predicate space determined by applying an NJMC predicate to the multi-column table.

At 956 a selectivity of the NJMC predicate is estimated by dividing the second size of the second polyhedron by the first size of the first polyhedron.

In some instances, 952, 954 and 956 may be performed according to descriptions provided of estimator 136. In some instances, 952, 954 and 956 may be performed according to descriptions provided of FIG. 5, 6, 7 or 8; or alternatively of FIGS. 7 and 8. 952, 954 and 956 may be performed according to descriptions of estimator (e.g., module) 136. In some instances, 952, 954 and 956 may be described as a computer-implemented method for computing a selectivity estimation of a database query.

FIG. 9C is a flow diagram of a process for performing geometric selectivity estimation according to example embodiments. More specifically, FIG. 9C shows process 960 for performing geometric selectivity estimation. In some cases process 960 includes selectivity estimation performed according to descriptions of estimator 136 of optimizer 134 of FIGS. 1-2. In some instances, process 960 is performed as part of 910-930 of process 900. In some instances, process 960 is performed as a replacement of 910-930 of process 900.

At 962 a plurality of variables for columns of a multi-column table are identified.

At 964, a range of values is applied to each of the plurality of variables to determine a first size of a first polyhedron that is a full space of a multi-column table (MCT). In some examples, this polyhedron may have one dimension for each column of the multi-column table.

At 966 the first size is restricted using an NJMC predicate to determine a second size of a second polyhedron that is a non-join multi-column (NJMC) predicate space of the multi-column table (MCT). This polyhedron may have one dimension for each column of a predicate space determined by applying an NJMC predicate to the multi-column table.

At 968 a selectivity of the NJMC predicate is estimated as a percentage of the second size of the second polyhedron divided by the first size of the first polyhedron.

In some instances, 962, 964, 966 and 968 may be performed according to descriptions provided of estimator 136. In some instances, 962, 964, 966 and 968 may be performed according to descriptions provided of FIG. 5, 6, 7 or 8; or alternatively of FIGS. 7 and 8. 962, 964, 966 and 968 may be performed according to descriptions of estimator (e.g., module) 136. In some instances, 962, 964, 966 and 968 may be described as a computer-implemented method for computing a selectivity estimation of a database query.

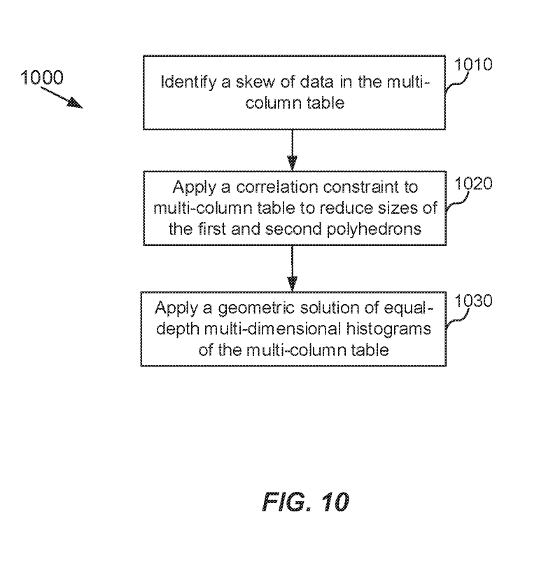

FIG. 10 is a flow diagram of a process for performing skew compensation as part of geometric selectivity estimation according to example embodiments. In some cases, FIG. 10 shows process 1000 for performing skew compensation (e.g., correction) prior to or as part of geometric selectivity estimation. In some cases, process 1000 includes skew compensation as described for compensator 232 of optimizer 134 of FIGS. 1-2. In some instances, process 1000 is performed as 905 of process 900. In some instances, correcting is performed according to the description provided of FIG. 7, 8 or 10; or alternatively of FIGS. 7 and 8. This correcting (e.g., process 1000) may be performed by compensator (e.g., module) 232, or any component in the system as described above.

At 1010, a skew of data is identified in a multi-column table. In some examples, this skew may be identified in a full space of the multi-column table. In some instances, this skew is a data spread skew and/or a frequency of data value skew.

At 1020, the skew is compensated for by applying a correlation constraint to the multi-column table that (1) reduces a first polyhedron that is a full space of a multi-column table to a smaller sized third polyhedron and (2) reduces a second polyhedron that is a non-join multi-column (NJMC) predicate space of the multi-column table to a smaller sized fourth polyhedron. In some examples, the first polyhedron may have one dimension for each column of the multi-column table; and the polyhedron may have one dimension for each column of a predicate space determined by applying an NJMC predicate to the multi-column table. In some instances, 1020 may be performed according to descriptions provided of compensator 232. In some instances, 1020 may be performed according to descriptions provided of FIG. 7, 8 or 10; or alternatively of FIGS. 7 and 8. 1020 may be performed by compensator (e.g., module) 232, or any component in the system as described above. In some instances, 1020 may be described as a computer-implemented method for compensating for skew prior to or during selectivity estimation of a database query.

At 1030, the skew is compensated for by applying a geometric solution to equal-depth multi-dimensional histograms of a multi-column table. In some examples, 1030 includes applying a geometric solution to equal-depth multi-dimensional histograms of a first polyhedron having one dimension for each column of the multi-column table. In some instances, 1030 may be performed according to descriptions provided of compensator 232. In some instances, 1030 may be performed according to descriptions provided of FIG. 7, 8 or 10; or alternatively of FIGS. 7 and 8. 1030 may be performed by compensator (e.g., module) 232, or any component in the system as described above. In some instances, 1020 may be described as a computer-implemented method for compensating for skew prior to or during selectivity estimation of a database query.

In some instances, process 1000 includes 1010 and 1020. In other instances process 1000 includes 1010 and 1030. In still another instance, the process 1000 includes 1010, 1020 and 1030.

It is appreciated that the above processes are non-limiting examples, and that any number of different query optimizer processes may be employed, with or without geometric estimated selectivity.

FIG. 11 is a block diagram of a device that can be used to implement various embodiments. Specific devices may utilize all of the components shown, or only a subset of the components, and levels of integration may vary from device to device. Furthermore, the device 1100 may contain multiple instances of a component, such as multiple processing units, processors, memories, transmitters, receivers, etc. The device 1100 may comprise a processing unit 1101 equipped with one or more input/output devices, such as network interfaces, storage interfaces, and the like. The processing unit 1101 may include a central processing unit (CPU) 1110, a memory 1120, a mass storage device 1130, and an I/O interface 1160 connected to a bus 1170. The bus 1170 may be one or more of any type of several bus architectures including a memory bus or memory controller, a peripheral bus or the like.

The CPU 1110 may comprise any type of electronic data processor. The memory 1120 may comprise any type of system memory such as static random access memory (SRAM), dynamic random access memory (DRAM), synchronous DRAM (SDRAM), read-only memory (ROM), a combination thereof, or the like. In an embodiment, the memory 1120 may include ROM for use at boot-up, and DRAM for program and data storage for use while executing programs. In embodiments, the memory 1120 is non-transitory. In some embodiments, the memory 1120 includes a skew compensation module 232 (optional) that corrects or compensates for data skew in a DB table of data, such as performed according to descriptions of FIGS. 1, 2, 7 and/or 8; at 905 of process 900; or of process 1000. In some embodiments, the memory 1120 includes a selectivity estimator module 136 that provides geometric estimated selectivity for NJMC predicates of queries of DB table of data, such as performed according to descriptions of FIGS. 1, 2, 5, 6, 7 and/or 8; at 910, 920 and 930 of process 900; of process 950; or of process 960.

In some embodiments, the memory 1120 includes a cardinality calculator module 238 that calculates cardinality based on geometric estimated selectivity for NJMC predicates of queries of DB table of data, such as performed according to descriptions of FIGS. 1, 2, 5, 6, 7 and/or 8; at 910, 920 and 930 of process 900; of process 950; or of process 960.

The mass storage device 1130 may comprise any type of storage device configured to store data, programs, and other information and to make the data, programs, and other information accessible via the bus 1170. The mass storage device 1130 may comprise, for example, one or more of a solid state drive, hard disk drive, a magnetic disk drive, an optical disk drive, or the like.

The processing unit 1101 also includes one or more network interfaces 1150, which may comprise wired links, such as an Ethernet cable or the like, and/or wireless links to access nodes or one or more networks 1180. The network interface 1150 allows the processing unit 1101 to communicate with remote units via the networks 1180. For example, the network interface 1150 may provide wireless communication via one or more transmitters/transmit antennas and one or more receivers/receive antennas. In an embodiment, the processing unit 1101 is coupled to a local-area network or a wide-area network for data processing and communications with remote devices, such as other processing units, the Internet, remote storage facilities, or the like.

Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment. Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

Some embodiments herein may be implemented in computer-readable non-transitory media that includes all types of computer readable media, including magnetic storage media, optical storage media, and solid state storage media and specifically excludes signals. It should be understood that the software can be installed in and sold with the optimizer 134 and/or estimator 136. Alternatively the software can be obtained and loaded into the optimizer 134 and/or estimator 136, including obtaining the software via a disc medium or from any manner of network or distribution system, including, for example, from a server owned by the software creator or from a server not owned but used by the software creator. The software can be stored on a server for distribution over the Internet, for example.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

For purposes of this document, each process associated with the disclosed technology may be performed continuously and by one or more computing devices. Each step in a process may be performed by the same or different computing devices as those used in other steps, and each step need not necessarily be performed by a single computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A computer-implemented method for computing a selectivity estimation of a database query, the method comprising:
representing a full space of a multi-column table (MCT) as a first polyhedron having at least one dimension for each column of the multi-column table;
representing a non-join multi-column (NJMC) predicate space as a second polyhedron having at least one dimension for each column of a predicate space determined by applying the NJMC predicate to the multi-column table; and
estimating a selectivity of the NJMC predicate by computing a percentage of a second size of the second polyhedron to a first size of the first polyhedron.

2. The computer-implemented method of claim 1, wherein the estimating further includes:
calculating the first size as one of a hyper volume in n-dimensions, or a number of integer points of the first polyhedron;
calculating the second size as one of a hyper volume in n-dimensions, or a number of integer points of the second polyhedron; and
the computing the percentage includes dividing the second size by the first size.

3. The computer-implemented method of claim 1, wherein
the representing the full space includes
identifying a plurality of variables for columns of the multi-column table;
the estimating includes
applying a range of values to each of the plurality of variables to determine the first size;
restricting the first size using the NJMC predicate to determine the second size; and
estimating the selectivity as a percentage of the second size divided by the first size.

4. The computer-implemented method of claim 1, wherein
the representing the full space includes defining the first polyhedron as a first n-dimensional, bounded polyhedron based on statistical calculations or estimations used on a plurality of columns of the multi-column table; and
the representing the NJMC predicate space includes defining the second polyhedron as a second n-dimensional, bounded polyhedron based on statistical calculations or estimations used on a plurality of columns of the NJMC predicate space that are a subset of the plurality of columns of the multi-column table.

5. The computer-implemented method of claim 1, and prior to representing a full space, further comprising:
identifying a skew of data in the multi-column table; and
compensating for the skew by one of a) applying a correlation constraint to the multi-column table that reduces the first polyhedron to a smaller sized third polyhedron and reduces the second polyhedron to a smaller sized fourth polyhedron, or b) applying a geometric solution to equal-depth multi-dimensional histograms of the multi-column table.

6. The computer-implemented method of claim 5, wherein applying a geometric solution includes:
selecting a plurality of equal-depth multi-dimensional histograms;
separately applying a geometric solution to each of the selected equal-depth multi-dimensional histograms; and
compensating for the skew based on adding the results from the separately applying.

7. The computer-implemented method of claim 1, and further comprising:
calculating a cardinality of the NJMC predicate using the estimated selectivity.

8. A database query selectivity estimator device, comprising:
a memory storage comprising instructions; and
one or more processors in communication with the memory, wherein the one or more processors execute the instructions to:
represent a full space of a multi-column table (MCT) as a first polyhedron having at least one dimension for each column of the multi-column table;
represent a non-join multi-column (NJMC) predicate space as a second polyhedron having at least one dimension for each column of a predicate space determined by applying the NJMC predicate to the multi-column table; and
estimate a selectivity of the NJMC predicate by computing a percentage of a second size of the second polyhedron to a first size of the first polyhedron.

9. The estimator device of claim 8, wherein the estimating further includes:
calculating the first size as one of a hyper volume in n-dimensions, or a number of integer points of the first polyhedron;
calculating the second size as one of a hyper volume in n-dimensions, or a number of integer points of the second polyhedron; and
the computing the percentage includes dividing the second size by the first size.

10. The estimator device of claim 8, wherein
the representing the full space includes
identifying a plurality of variables for columns of the multi-column table;
the estimating includes
applying a range of values to each of the plurality of variables to determine the first size;
restricting the first size using the NJMC predicate to determine the second size; and
estimating the selectivity as a percentage of the second size divided by the first size.

11. The estimator device of claim 8, wherein
the representing the full space includes defining the first polyhedron as a first n-dimensional, bounded polyhedron based on statistical calculations or estimations used on a plurality of columns of the multi-column table; and
the representing the NJMC predicate space includes defining the second polyhedron as a second n-dimensional, bounded polyhedron based on statistical calculations or estimations used on a plurality of columns of the NJMC predicate space that are a subset of the plurality of columns of the multi-column table.

12. The estimator device of claim 8, and prior to representing a full space, further comprising the one or more processors executing the instructions to:
identify a skew of data in the multi-column table;
compensate for the skew by one of a) applying a correlation constraint to the multi-column table that reduces the first polyhedron to a smaller sized third polyhedron and reduces the second polyhedron to a smaller sized fourth polyhedron, or b) applying a geometric solution to equal-depth multi-dimensional histograms of the multi-column table.

13. The estimator device of claim 12, wherein applying a geometric solution includes:
selecting a plurality of equal-depth multi-dimensional histograms;
separately applying a geometric solution to each of the selected equal-depth multi-dimensional histograms; and
compensating for the skew based on adding the results from the separately applying.

14. The estimator device of claim 12, and further comprising the one or more processors executing the instructions to:
calculate a cardinality of the NJMC predicate using the estimated selectivity.

15. A non-transitory computer-readable medium storing computer instructions for computing a selectivity estimation of a database query, that when executed by one or more processors, cause the one or more processors to perform the steps of:
represent a full space of a multi-column table (MCT) as a first polyhedron having at least one dimension for each column of the multi-column table;
represent a non-join multi-column (NJMC) predicate space as a second polyhedron having at least one dimension for each column of a predicate space determined by applying the NJMC predicate to the multi-column table; and
estimate a selectivity of the NJMC predicate by computing a percentage of a second size of the second polyhedron to a first size of the first polyhedron.

16. The non-transitory computer-readable medium of claim 15, wherein the estimating further includes:
calculating the first size as one of a hyper volume in n-dimensions, or a number of integer points of the first polyhedron;
calculating the second size as one of a hyper volume in n-dimensions, or a number of integer points of the second polyhedron; and
the computing the percentage includes dividing the second size by the first size.

17. The non-transitory computer-readable medium of claim 15, wherein
the representing the full space includes
identifying a plurality of variables for columns of the multi-column table;
the estimating includes
applying a range of values to each of the plurality of variables to determine the first size;
restricting the first size using the NJMC predicate to determine the second size; and
estimating the selectivity as a percentage of the second size divided by the first size.

18. The non-transitory computer-readable medium of claim 15, wherein
the representing the full space includes defining the first polyhedron as a first n-dimensional, bounded polyhedron based on statistical calculations or estimations used on a plurality of columns of the multi-column table; and
the representing the NJMC predicate space includes defining the second polyhedron as a second n-dimensional, bounded polyhedron based on statistical calculations or estimations used on a plurality of columns of the NJMC predicate space that are a subset of the plurality of columns of the multi-column table.

19. The non-transitory computer-readable medium of claim 15, and prior to representing a full space, further comprising computer instructions, that when executed by one or more processors, cause the one or more processors to perform the steps of:
identify a skew of data in the multi-column table; and
compensate for the skew by one of a) applying a correlation constraint to the multi-column table that reduces the first polyhedron to a smaller sized third polyhedron and reduces the second polyhedron to a smaller sized fourth polyhedron, or b) applying a geometric solution to equal-depth multi-dimensional histograms of the multi-column table.

20. The non-transitory computer-readable medium of claim 15, and further comprising computer instructions, that when executed by one or more processors, cause the one or more processors to perform the steps of:
calculate a cardinality of the NJMC predicate using the estimated selectivity.
